(19) United States
(12) Patent Application Publication
(10) Pub. No.: US 2014/0278532 A1
(43) Pub. Date: Sep. 18, 2014

(54) Payment Request-Triggered, Pull-Based Collection of Electronic Health Records

(71) Applicant: Ravi K. Kalathil, Denver, CO (US)

(72) Inventor: Ravi K. Kalathil, Denver, CO (US)

(21) Appl. No.: 13/839,539

(22) Filed: Mar. 15, 2013

(51) Int. Cl. G06F 19/00

(52) U.S. Cl. CPC G06F 19/328
USPC 705/3

(57) ABSTRACT

EHR data of a Patient is collected from a Provider for each instance of the Provider delivering Healthcare to the Patient, and that collected EHR data is aggregated with any pre-existing EHR data of the Patient to create augmented EHR data for the Patient. The EHR data is collected from the Provider in response to a payment request submitted by the Provider to a Payer, and other techniques.

This invention relates to establishing a comprehensive aggregation of Electronic Health Records (EHRs) for each of many patients. More particularly, the invention is a new and improved technique which uses claims or requests for payment from physicians and other health care providers (Providers) to a healthcare insurer or an entity responsible for payment of healthcare expenses (Payer) as a basis to request and receive (“pull”) medical records from Providers to establish and populate a comprehensive EHR for each patient.

### BACKGROUND OF THE INVENTION

As discussed herein, a person seeking or receiving healthcare services or products is referred to as a “Patient.” Healthcare providers that deliver healthcare products and services to a Patient are referred to herein as “Providers.” Providers include doctors, doctor offices, clinics, surgical centers, laboratories, hospitals, urgent care centers, pharmacies, rehabilitation centers and physical therapists, etc. Each individual healthcare service and product delivered to a Patient by a Provider, and all of the healthcare services and products so delivered, are referred to herein as “Healthcare.” An Electronic Health Record (EHR) is a description of a Patient's health status and health records, which is electronically readable and is suitable for access electronically through a public computer network, such as the internet. An EHR also includes an Electronic Medical Record (EMR). An EMR is specific to the clinical record description of each medical health encounter, intervention, administered medication, laboratory test results and other related healthcare information. In addition to the EMR for each Patient, the EHR also includes a broader narrative and commentary regarding a Patient's health record.

In 2009, the Congress of the United States passed legislation which established the Health Information Technology for Economic and Clinical Health Act (HITECH Act or as used herein the “Act”), under Title XIII of the American Recovery and Reinvestment Act. The Act mandates that Providers commence using a set of digital healthcare standards and specifications called Meaningful Use (MU). The MU standards establish a format and definition of an EHR. The MU standards also establish a uniform protocol for communication and information exchange of EHRs between Providers.

Through a system of incentives and penalties, Providers are encouraged to implement electronic/information technology (IT) systems that store each Patient's EHR and that are capable of communicating that EHR data on demand, all in accordance with the MU standards. A principal purpose of the MU standards is to establish a basis for Providers to exchange EHR data about Patients in a timely manner. The exchange of EHR's offers the possibility of increased coordination in care between Providers. The expectation is that the advantages and benefits of timely and comprehensive EHR data exchange will increase the quality of healthcare and safety of the Patient, and help manage healthcare costs. Once a Provider establishes such an electronic EHR data storage and communication system, a governmental regulatory organization will test and certify the system as MU compliant. The Act requires Providers to achieve certification prior to 2014 to be eligible to collect certain incentives. If the certification is not achieved before 2014, penalties may be assessed against the Providers.

The benefits of communicating a Patient's EHR allows access to more complete medical information about a Patient. Knowledge of more complete medical information should lead to better diagnoses and outcomes. Duplication of previous laboratory tests and pharmaceutical prescriptions is avoided. Redundant and ineffective treatment combinations and sequences, as well as previously-unsuccessful treatments, need not be repeated. Other benefits also accrue.

In the past, there have been attempts by entities to establish a comprehensive medical record for Patients through Personal Health Repositories (PHR). In simple terms, a PHR is a readily-accessible storage facility, vault or repository for the Patient's medical information. Under the terms of a personal contract between the Patient and the PHR entity, the medical information of each Patient is stored in electronically accessible manner to enable a Provider to access that medical information with the consent of the Patient. The medical information is not stored in a standardized format, because each PHR entity establishes its own format for that medical information. The lack of a non-standardized format for storing and presenting the information complicates the task of communicating the Patient's medical information.

To use the PHR, the Patient must affirmatively authorize a Provider to send or transmit, i.e. “push,” the Patient's medical information to the PHR vault. For each instance of Healthcare delivery, the Patient may be required to request the Provider to push the information to the PHR vault. Patients sometimes fail to make such requests, and even when requested, administrative mistakes may prevent transmission of the medical information. The burden to transmit the information falls on the Provider. In general, Providers view such requests as extra actions for which they will not receive compensation. Providers therefore resist requests from Patients to push their medical information to PHR vaults.

The underlying assumption of the PHR vault is that Patients will not seek Healthcare from Providers who are unwilling or unable to transmit the medical information to the PHR vault. This assumption has proved faulty, however, because most Patients remain committed to Providers because of issues of trust, past history, convenience, referrals, relationships, quality outcomes, cost and insurance coverage, support and compliance. Consequently, the use of PHR vaults has been minimal.

Another problem with the PHR model is that the Patient's medical information must be in a particular format established by the PHR vaulting entity, and that particular format may not be compliant with the format used by the Provider's clinical computer systems. Without complying with the format, the PHR vaulting entity is unable to store the medical information. Communication using the same format is also necessary to allow the Provider to access the Patient's medical information stored in the PHR vault. Providers are unwilling to change their clinical computer systems and software just to coordinate with the format requirements of the PHR vaulting entity.

Prior art developments have addressed some of the issues associated with PHR vaults, but those developments are more technical in nature, rather than addressing some of the fundamental implementation and use issues of PHR vaults. For example, the prior art developments focus on the automated aggregation of Patient's medical information, optimal storage techniques, and interface and translation techniques to communicate information between a diversity of different clinical computer systems used by Providers, among other things.

Complying with the MU standards under the Act effectively overcomes many of the deficiencies and detriments of PHR systems. Using the standardized MU protocol for communicating the EHR data assures that all MU-compliant Providers can send and receive EHR's electronically, and that the communicated EHR will be recognized and understood by the Provider.

Complying with the MU standards do not, however, resolve all of the important issues necessary for widespread successful implementation of the Act. Perhaps one of the most significant unresolved issues relates to the requirement for the Patient to identify past Providers. From a list of past Providers provided by the Patient, the present Provider is expected to electronically request and receive the EHRs from the past Providers. It seems unlikely that the Patient will remember and/or accurately identify all past Providers, particularly when Patient arrives at the Provider in unplanned or emergency conditions under extreme anxiety. It is also unlikely that Providers will undertake the burden of collecting all of the past EHR records for the Patient. From the perspective of the past Provider, it is unclear how the legitimacy of requests for the EHR records of Patients will be ascertained as originating from a legitimate Provider whom the Patient has authorized to request such information. Errors in Patient identification and Provider identification compound the difficulties surrounding these issues.

### SUMMARY OF THE INVENTION

This invention presents a solution to many of the unresolved issues under the Act and the MU standards. In accordance with the present invention, a timely, accurate and comprehensive aggregation of EHR data is reliably established for each Patient, without imposing the burden and uncertainty on the Patient to accurately and completely identify past Providers. Providers are not burdened with any efforts and liabilities of delivering the EHR data beyond those required by the Act. A more complete EHR of the Patient is readily available to a Provider in response to a single request, without burdening the Provider to send multiple requests to multiple Providers and assembling the collected EHR data in usable form. More accurate, timely and comprehensive EHR data for a Patient is available to the Provider at a diminished burden.

A central aspect of the invention is a response to a payment request made by a Provider to a Payer. The payment request to the Payer becomes a trigger or an initiator for an EHR Aggregator to request EHR data from the Provider that submitted the payment request. The EHR data received by the Aggregator in response to the request is used to augment the EHR for each Patient, and that augmented EHR is stored by the Aggregator and made available to Providers. Since each Provider will reliably and consistently submit a payment request to the Payer after delivering Healthcare to the Patient, the Provider's payment request to the Payer assures that there is new or additional EHR data to be collected for updating the Patient's EHR. No additional administrative burden is placed on the Provider beyond normal activity of submitting the payment request to the Payer, and no burden is placed on the Patient to recall the identities of all Providers or to request that the Providers push the additional EHR data to a vaulting entity.

Payers require a payment request in a standard format which uniquely identifies the Patient, the Provider, and describes the basic Healthcare delivered. The Payer supplies this identification and basic information to the Aggregator. The Aggregator then uses the identification information possibly along with at least one aspect of the basic Healthcare delivered to request and obtain, i.e. pull, the complete EHR from the Provider using MU standards. There is no administrative burden on the Provider to respond to the requests from the Aggregator, since those requests will be initiated and responded to on an automatic basis consistent with the MU-compliant clinical computer systems of the Provider. Since almost all Healthcare delivery is subject to a payment request to a Payer, complete EHR data for each Patient will be collected, aggregated and augmented on a timely, reliable, and comprehensive basis without additional requirements imposed on the Provider or Patient.

These and other beneficial aspects of the present invention arise from a method of collecting and aggregating EHR data of a Patient to whom Healthcare is delivered by a Provider, under circumstances where the Provider creates the EHR data and submits a payment request to a Payer for compensation for Healthcare delivery to the Patient. The EHR data from the Provider is collected, aggregated and augmented for each instance of the Provider submitting the payment request to the Payer for compensation for Healthcare delivery to the Patient. The collected EHR data is aggregated with any pre-existing EHR data to create augmented EHR data for the Patient.

Other subsidiary aspects of the invention include some or all of the following features. Collection of the EHR data is initiated in response to a trigger supplied by the Payer, and that trigger includes an identification of the Patient, an identification of the Provider, and a basic description of the Healthcare delivered to the Patient contained in the payment request submitted by the Provider to the Payer. The EHR data of the Patient is collected, aggregated and augmented by an Aggregator that has authority to access the EHR data of the Patient, that is not a Provider who submits the payment request to the Payer, and that is not the Provider that delivered Healthcare to the Patient. The EHR data of the Patient may be collected, aggregated and augmented. The Aggregator derives the authority to communicate with each Provider who delivers Healthcare to the Patient by obtaining the consent for such communication from the Patient or by obtaining the lawful regulatory status as a Provider.

Pre-existing EHR data of the Patient may be collected and included in the augmented EHR data by obtaining the pre-existing data from one or more Payers who previously compensated a Provider for delivering Healthcare to the Patient, or from one or more Providers who previously delivered Healthcare to the Patient, or from statements describing Healthcare delivered, or from a PHR vault containing medical information of the Patient.

The EHR data of the Patient may also be collected by periodically requesting the EHR data from each Provider who has previously delivered Healthcare to the Patient, by requesting EHR data for the Patient from a class of other Providers that could have delivered Healthcare to the Patient based on at least one aspect of the basic description of the Healthcare delivered to the Patient as contained in the payment request, or from Providers that have geographic addresses within a predetermined geographic proximity of the address of the Provider submitting the payment request or the Patient. The EHR data of the Patient may also be collected by periodic requests to a Provider that has previously requested the aggregated EHR data of the Patient in connection with delivering Healthcare to the Patient.

The inventive aspects are described specifically in the appended claims. A more complete appreciation of the inventive aspects and their scope, as well as the manner in which they obtain improvements and other benefits, is available from the following detailed description of presently preferred embodiments and the accompanying drawings, which are briefly summarized below.

### BRIEF DESCRIPTION OF THE DRAWINGS

FIG. 1 is a block diagram showing entities, actions and communications involved in practicing the present invention.

FIG. 2 is a flowchart illustrating actions performed by the entities shown in FIG. 1 when practicing the present invention to collect, aggregate and augment EHR data.

FIG. 3 is a flowchart illustrating actions performed by a Provider to obtain EHR data which has been previously collected, aggregated and augmented as shown in FIGS. 1 and 2.

### DETAILED DESCRIPTION

The EHRs of Patients 20 are collected and augmented automatically by the interaction and communication between Providers 22, Payers 24 and at least one EHR Aggregator 26, as shown in FIG. 1. The Patients 20, Providers 22, Payers 24 and Aggregator 26 interact with one another by communicating and taking those actions shown in FIGS. 1 and 2. For convenience of illustration and description, FIG. 1 illustrates instances of a single Patient 20 interacting with a single Provider 22 and that single Provider 22 interacting with a single Payer 24. In actual practice, a single Patient 22 could interact with multiple Providers 22, and each Provider 22 could interact with multiple Payers 24. Although only a single Aggregator 26 is shown, multiple Aggregators 26 may exist, and under such circumstances, multiple Payers 24 could interact with multiple Aggregators 26. In such circumstances, the actions and communications illustrated in FIGS. 1 and 2 will be replicated for each instance of one interaction between a Patient and a Provider. Except in those instances where the actions and communications must be performed by humans, the actions and communications described are anticipated to be performed by electronic computer and communications devices which have been programmed to execute the functions described.

The Patient 20 begins by seeking Healthcare from a Provider 22. This relationship is established in a Patient-Provider transaction 28 shown in FIG. 1. The Patient-Provider transaction 28 involves the Provider 22 obtaining appropriate identification of the Patient shown at 30 (FIG. 2). Appropriate Patient identification authenticates the identity of the Patient seeking the Healthcare, and assures that the EHR will be established for the correctly identified Patient.

As part of the Patient-Provider transaction 28, the Provider 22 delivers Healthcare to the Patient 20 in the normal manner, as shown at 32 (FIG. 2). In conjunction with delivering the Healthcare, the Provider 22 establishes the EHR that describes the Healthcare delivered to the Patient. The EHR created by the Provider 22 is established in MU-compliant form, and that MU-compliant EHR is then stored locally in a local memory 34 of the clinical computer system of the Provider 22, as shown at 36 (FIG. 2).

The Provider 22 thereafter seeks payment for the Healthcare delivered to the Patient 20, by submitting a payment request 38 to the Payer 24 that is responsible for paying for the Healthcare delivered to the Patient 20, as shown at 40 (FIG. 2). The payment request 38 submitted by the Provider 22 to the Payer 24 is in a standardized format established by the Payer for payment requests. The standardized format for payment requests includes information which identifies the Patient and the Provider, and information which contains a basic description of the Healthcare delivered by the Provider to the Patient. This standardized format of information is required by the Payer 24 to evaluate the legitimacy and the extent of the payment request. Although not shown, in response to a proper payment request 38, the Payer 24 will send payment to the Provider 22.

The Payer 24 then transmits a payment request trigger 42 to the Aggregator 26, as shown at 44 (FIG. 2). The payment request trigger 42 includes the identifications of the Patient and the Provider and a basic description of Healthcare delivered, derived from or based on the information contained in the payment request 38. The Aggregator 26 interprets the payment request trigger as an indication that Healthcare has been delivered to the identified Patient by the identified Provider. In response to the payment request trigger 42, the Aggregator 26 commences action to establish, collect and augment an EHR record for the identified Patient, by collecting information from the EHR stored in the local memory 34 of the identified Provider 22.

In preparation for establishing, collecting and augmenting the EHR record for each identified Patient, the Aggregator 26 extracts from the payment request trigger 42, the identity of the Patient, the identity of the Provider, and the basic EHR data contained in the payment request trigger 42, as shown at 46 (FIG. 2). The information extracted from the payment request trigger 42 is then stored by the Aggregator 26 in a basic EHR memory vault 48, as shown at 50 (FIG. 2).

Using the extracted identification of the Provider 22 and the Patient 20, the Aggregator 26 sends a pull request 52 to the identified Provider 22, as shown at 54 (FIG. 2). The pull request 52 includes the identification of the Patient 20, and constitutes a request for the Provider 22 to obtain from the local memory 34, the MU-compliant EHR data of the identified Patient and to transmit that EHR back to the Aggregator 26. In addition to the identity of the Patient, the pull request 52 may also include at least one aspect of the basic EHR data contained in the payment request trigger. Exemplary aspects of the basic EHR data, which are contained in the payment request and carried through in the payment request trigger, are discussed below.

The Provider 22 responds to the pull request 52 in a pull reply 56. The pull reply 56 involves obtaining the MU-compliant EHR data of the identified Patient from the local memory 34 and transmitting that EHR back to the Aggregator 26, as shown at 58 (FIG. 2). The EHR data transmitted by the Provider constitutes the major part of the pull reply 56 and includes comprehensive information describing the Healthcare delivered to the identified Patient. The EHR data returned in the pull reply is more complete, compared to the basic description contained in the payment request trigger 42. Accordingly, the EHR data provided to the Aggregator 26 in the pull reply 56 is a more complete record of the Healthcare delivered to the identified Patient.

With the more complete EHR data in the pull reply 56 from the Provider 22, the Aggregator 26 updates the basic EHR data obtained from the payment request trigger and stored in the basic EHR memory vault 48. The updated and more complete EHR data constitutes the augmented EHR record of the Healthcare delivered to the identified Patient by the identified Provider. The augmented EHR record for the Patient is thereafter stored in an augmented EHR vault 60, as shown at 62 (FIG. 2).

The previously described series of transactions and interactions is repeated each time a Patient obtains Healthcare delivered by a Provider. Each new instance of a Provider delivering Healthcare results in augmentation of the augmented EHR record of each Patient, after the Provider submits the payment request 38 and the Payer transmits the payment request trigger 42 to the Aggregator 26. In this manner, the EHR record of each Patient is automatically updated for each instance of an additional Patient-Provider transaction 28. Additional techniques for augmenting the EHR record of each Patient based on previously-occurring Patient-Provider transactions are referred to at 64 (FIG. 2) and are discussed in greater detail below. The augmentation of the Patient's EHR record based on the Healthcare previously delivered to the Patient establishes a historically more-complete augmented EHR record.

The augmented EHR record of each Patient stored in the augmented EHR vault 60 is accessible to a Provider 22 for use in conjunction with delivering future Healthcare. The technique of accessing the augmented EHR record of each Patient in the augmented EHR vault 60 is described in conjunction with FIGS. 1 and 3.

A new or existing Patient 20 requests Healthcare from a new or existing Provider 22, and a Patient-Provider transaction 28 is initiated. The Provider 22 authenticates the Patient by obtaining the Patient's identification in the same manner as previously described, as shown at 66 (FIG. 3). Then, as part of the Patient-Provider transaction 28, the Provider 22 sends an EHR request 68 to the Aggregator 26, as shown at 70 (FIG. 3). The EHR request 68 includes the identification of the Patient 20 and the identification of the Provider 22.

The Aggregator 26 responds to the EHR request 68 by obtaining a copy of the augmented EHR record for the identified Patient from the augmented EHR vault 60.

An EHR reply 72 is communicated from the Aggregator 26 to the Provider 22 identified in the EHR request 68, as shown at 74 (FIG. 3). The EHR reply 72 includes a copy of the augmented EHR record for the identified Patient as exists in the augmented EHR vault 60.

Upon receiving the augmented EHR record for the identified Patient in the EHR reply 72, the Provider 22 creates a local record of the augmented EHR and stores that record in the local memory 34 for that Patient, as shown at 76 (FIG. 3), if the Patient is a new Patient. If the Patient is an existing Patient, the Provider 22 updates the pre-existing local EHR record stored in the local memory 34 for that Patient with the most current augmented EHR record contained in the EHR reply 72, as shown at 76 (FIG. 3).

After updating the local EHR record of the Patient with the augmented EHR record received from the Aggregator 26, and after delivering Healthcare to the Patient, the Provider 22 again updates the local EHR record to reflect the Healthcare delivered. That updated EHR record is then stored in local memory 34. When the Provider 22 sends a payment request 38 to a Payer 24 to receive compensation for the Healthcare delivered, the previously described actions which lead to augmenting the Patient's EHR data commence, so that the updated local EHR record in the local memory 34 is transmitted to the Aggregator 26 as part of a pull reply 56 to the EHR Aggregator 26. The most current information from the EHR data received in the pull reply 56 is used by the Aggregator 26 to augment the EHR record of the Patient stored in the augmented EHR vault 60. In this manner, a contemporaneous, comprehensive and augmented EHR record for the Patient is established in the augmented EHR vault 60 for each Patient and that augmented EHR record becomes available to a Provider when additional Healthcare is delivered to the Patient.

As described above, recognizable MU-compliant information describing the augmented EHR of the Patient is readily available. No initiatives from the Patient or further efforts from the Provider are required to collect and augment the EHR data of the Patient. The payment requests 38 and the payment request triggers 42 constitute a reliable basis for collecting, aggregating and augmenting EHR data of the Patient stored in the augmented EHR vault 60. The timely comprehensiveness of the EHR data made available to Providers enhances the quality of healthcare, and safety of the Patient and serves as an improved basis to manage healthcare costs.

For purposes of clarity of description, each payment request 38, each payment request trigger 42, each pull request 52, a each pull reply 56, each EHR request 68 and each EHR reply 72 is shown as a separate and direct communication between the entities involved. In actual practice, these communications are performed over a public information network, such as the Internet. Such communications are possible because of the unique public network addresses of the Providers 22, the Payers 24, and the Aggregator 26. These communications, although shown as direct, can occur through intermediate entities such as clearing houses and health information exchanges. The scope of the present invention encompasses communications occurring through intermediate entities.

For the Aggregator 26 to perform interactively with the Providers 22 in the manner previously described, the Aggregator 26 must attain the status of a Provider under the MU standards. The Provider status of the Aggregator under the MU standards may be obtained with the consent of the Patient 20 as part of the Patient-Provider transaction 28, for example. Provider status of the Aggregator under the MU standards may also be negotiated with governmental regulatory bodies as part of the implementation of the Act. To become a Provider, the Aggregator must provide Healthcare under the MU standards, such as, for example, establishing and providing diagnostic and health monitoring services to the Patient in his or her home. The benefit of having the augmented EHR data available for use by Providers is an incentive for Patients to authorize the Aggregator as a Provider in the Patient-Provider transaction 28. The Aggregator 26 may also directly obtain authorization as a Provider from the Patient. To obtain the status of a Provider, the Aggregator must obtain the certifications applicable to Providers.

Authentication of the Patient 20, as part of the Patient-Provider transaction 28, involves obtaining and/or confirming the Patient's name (usually first name, middle name, last name), the date of birth of the Patient and a Payer health identification number (PHIN). The PHIN is a unique number assigned to each Patient by a Payer and is present on a Patient's insurance card or other information which identifies the Payer as responsible for paying healthcare costs of the Patient. The PHIN number along with the name and date of birth are recorded by a Provider as part of the Patient-Provider transaction 28 and are included in each payment request 38. The Patient's name and date of birth may also be confirmed from another form of identification such as a driver's license. Careful collection of the Patient's identification information is essential for the Provider to receive payment from payment requests 38.

The Aggregator 26 can use the ANSI X12N 270/271 Health Care Eligibility Benefit Inquiry and Response transaction regulations to obtain additional information about the Patient. The Aggregator sends an ANSI X12N 270 request to the Payer with the PHIN, Patients name and Patient's date of birth. The Payer responds in a HIPAA 271 communication, which provides the Aggregator with the Patient's address including city, state and zip code as well as the Patient's gender. The Aggregator may use this enhanced Patient identification information as part of its database to ensure accurate collection of the EHR data for the Patient.

Each Provider is identified by a National Provider Identifier (NPI). The NPI uniquely identifies each Provider within a registry of Providers supported by the National Plan and Provider Enumeration System (NPPES). A Provider must register with NPPES and acquire a NPI in order to deliver Healthcare in the United States. As part of this registration, the Provider provides certain identifying information to NPPES. The Aggregator may query the NPPES database using the NPI code to obtain additional details regarding the Provider, such as the geographic address of the Provider and taxonomy codes which identify the type and area of specialization of the Provider. The Aggregator may use this enhanced Provider identification information as part of its database to ensure accurate collection and timely aggregation of the EHR data of a Patient.

Communication between the Providers 22, the Payers 24 and the Aggregator 26 is facilitated by the Health Insurance Portability and Accountability Act of 1996 (HIPAA). HIPPA establishes a standard for Electronic Data Interchange (EDI) between Providers and Payers. The EDI Healthcare Claims Transaction Set (HIPAA Transaction 837) establishes a prevalent and widely utilized template for the components of the payment requests 38 from a Provider to a Payer. Further details are defined in the 4010/5010 ANSI ASC X12N 837 Healthcare Claims Transmission Set, but those components always include the identity of the Patient, the identity of the Provider and aspects of the basic EHR data involved in delivering Healthcare to the Patient in each Patient-Provider transaction 28.

Since the HIPPA standards must be adhered to for any electronic data interchange between Payers and Providers, and since electronic payment requests 38 result in faster payments to Providers, compared with paper claims, almost all payment requests 38 are submitted electronically. Each payment request trigger 42 includes aspects of the HIPPA-standardized information which is incorporated in each payment request 38. The necessary information for the Aggregator 26 to initiate a pull request 52 is readily available from aspects of the HIPPA-standardized information contained in each payment request trigger 42.

At the present time in United States, there are six Payers who offer Healthcare insurance or Healthcare payment coverage to approximately 170 million Patients. Those Payers are CMS (Medicare), United Healthcare, Wellpoint, Aetna, Cigna and Humana. Consequently at the present time, the Aggregator 26 needs only to acquire familiarity with a few different formats of payment requests 38 to extract information from the payment request triggers 42 which is beyond the purview of the HIPPA standards.

For pharmacy, dental, medical laboratory and other healthcare entities, there are specific transaction definitions similar to the HIPAA 837. For example in a retail pharmacy claim transaction, a National Council for Prescription Drug Programs (NCPDP) telecommunication standard is used as the basis for EDI payment requests 38 from pharmacy Providers to Payers. The details of these EDI transaction protocols vary but the basic information communicated is similar, and always includes a Patient identification, a Provider identification, and a basic description of the Healthcare delivered.

Aspects of the basic EHR data which the Aggregator may employ in pull requests, and which are also contained in payment requests 38 and repeated in payment request triggers 42, include an International Classification of Diseases (ICD) code which indicates the disease or condition treated by the Provider, a Current Procedural Terminology (CPT) code which describes the medical procedure performed by the Provider on the Patient, a National Drug Code (NDC) which describes the drug prescribed, the dosage of the drug, and the date when the Healthcare was delivered to the Patient. The ICD, CPT and NDC codes and dates are a consistent set of definitions utilized by Payers and Providers.

The augmented EHR record of a Patient includes the information contained in the EHR record created by the Provider. The EHR record obtained from the local memory 34 of the Provider may include additional information, such as a list of allergies, medication lists, drug-to-drug contraindications, food-to-drug contraindications, laboratory results, immunization history, family history, physician notes, discharge summaries, hospitalization summaries, long and short term plans of care, laboratory tests that were ordered, and radiology scans, among other things. This additional data is part of the EHR definitions in the MU standard and will therefore be available in MU-compliant systems.

It is advantageous for the historically complete EHR record of the Patient to be available in the augmented EHR vault 60. Augmenting EHR record of a Patient in response to a payment request ensures that the Patient's EHR record is updated whenever a Provider delivers Healthcare to the Patient. There are number of techniques for obtaining historical EHR data to include in the augmented EHR record.

Payment requests 38 submitted to Payers 24 are typically maintained by Payers for a considerable length of time, for example fourteen years. Consequently, the PHIN for a Patient can be used by the Aggregator to access the historical basic EHR records of the Patient stored by the Payer in connection with previous payment requests. Those historical records can thereafter be used to augment the EHR record, and to send pull requests 52 to the Providers that delivered the Healthcare. Provided that the historical local EHR records of the Providers are MU-compliant, those records are collected and incorporated in the Patient's augmented EHR record.

In those circumstances where the Patient has changed Payers in the past, the Patient can procure his or her PHIN assigned by the past Payer. The past PHIN is then submitted to Aggregator 26. In response, the Aggregator submits pull requests 52 to Providers based on the Patient's identification as supplied by the past Payer. Those Providers having information which comply with the pull requests 52 respond with pull replies 56. The EHR data contained in the pull replies 56 is then integrated into the augmented EHR data of the Patient.

Patients can also submit other records to the Aggregator which contain information that describes historical Healthcare delivered. The Aggregator will augment the Patient's EHR record based on those records. For example, Healthcare delivery information is available from a so-called “super bill” that is generated by a Provider at the time of delivering Healthcare. The super bill includes much detail concerning the Healthcare delivered to the Patient, and frequently includes codes which are MU-compliant. A Provider may give a copy of the super bill to the Patient, and the Patient can then supply the super bill to the Aggregator. The medical information from the super bill is then aggregated into the augmented EHR record by the Aggregator.

In those limited circumstances where Patients have established and maintain a PHR, the Patient may give the Aggregator 26 access to the PHR. The medical information contained in the PHR is then used by the Aggregator to augment the EHR records of the Patient stored in the augmented EHR vault 60.

Other techniques may be used to obtain augmented EHR data before the Provider submits a payment request 38 to the Payer 24. The principal benefit to augmenting the EHR record by use of these techniques is a more timely delivery of the Patient's augmented EHR data, compared to waiting to augment the EHR data based on a payment request 38 and a payment request trigger 42. Although unusual, the Provider may delay submitting the payment request 38 to the Payer 24, and/or the Payer may delay submitting the payment request trigger 42 to the Aggregator 26. Under these circumstances, the EHR record is augmented with local EHR data obtained from the Provider before the Provider submits a payment request 38 and before the Payer transmits the payment request trigger 42. The later transmission of the payment request trigger 42 is used by the Aggregator to confirm the accuracy of any information previously obtained.

Once the EHR records of a Patient have been obtained from a Provider, The Aggregator 26 may periodically send pull requests 52 to the same Provider requesting the EHR records which may have been created since the Provider delivered the last pull reply 56. This procedure is based on the assumption that the Patient may return to the Provider for future Healthcare.

The Aggregator 26 can algorithmically send pull requests 52 to Providers. For example, a pull reply 56 from a Provider containing EHR data of a surgical preparation procedure would establish a reasonable basis for a pull request 52 relating to surgical information, post surgical treatments, laboratory tests, biopsies, pharmacy transactions, prescriptions and discharge summaries, etc., all of which are typically associated with the execution of a surgical procedure.

Only a few laboratory medical service entities and pharmacies cover most of the laboratory and pharmacy services offered to Patients in the United States. For laboratory medical services in the United States, Quest Diagnostics and Labcorp presently have the substantial majority market share of non-hospital based laboratory testing. The Aggregator can periodically send pull requests 52 to these two companies for laboratory testing EHR data pertaining to a Patient. The information contained in any pull reply 56 typically identifies those Providers which ordered the medical tests, and the Aggregator can further send pull requests 52 to those identified Providers. In the case of pharmacy services, a United States entity known as Surescripts acts as a clearinghouse for electronic prescriptions from a Provider to a retail pharmacy. The significant majority of prescriptions in the United States are funneled through Surescripts. The Aggregator can send pull requests 52 to Surescripts or to other similar intermediaries by which to obtain augmented EHR data. This information will again include the identities of prescribing Providers to which the Aggregator 26 can send further pull requests 52.

Providers are usually geographically close to one another. For example, a Healthcare consultation to a dermatologist Provider may involve screening for melanoma and carcinoma skin cancer, followed by consultation with a biopsy surgeon Provider who is located within a short geographical distance from the dermatologist. As another example, a consultation with an endocrinologist Provider may be followed by a consultation to a podiatrist Provider for Healthcare to the foot, because some Patients with endocrinology diseases also have foot diseases. Based on these assumptions, the Aggregator may send pull requests 52 to those Providers located in a reasonably close geographic proximity to the address of the Provider which submitted the payment request 38.

As part of the Patient-Provider transaction 28, the Provider will usually generate an EHR request 68 to the Aggregator in conjunction with delivering the Healthcare. In response, the Provider will receive an EHR reply 72 that contains the augmented EHR data for the Patient. In many cases, the augmented EHR data will be requested and obtained by the Provider before delivering Healthcare to the Patient. When an EHR request 68 is received, the Aggregator 26 can reasonably assume that the EHR request 68 is made because the Provider has or will soon deliver Healthcare to the Patient. Based on this assumption, the Aggregator periodically sends a pull request 52 to the Provider who previously sent the EHR request 68. This approach to augmenting the EHR data for Patient in the augmented EHR vault 60 is termed herein as a “reciprocal pull.” Reciprocal pulls are more likely to obtain new EHR data by which to augment the EHR record for each Patient before the payment request 38 is submitted to the Payer 24 or the payment request trigger 42 is delivered to the Aggregator 26.

A variety of typical processing techniques may be employed by the Aggregator to aggregate the EHR records, past and present, into the augmented EHR records stored in the augmented EHR vault 60. Such processing is facilitated by establishing a reference table for the Patient identification information, and a reference table for the provider identification information, and classically normalizing the Patient and Provider identity information into those reference tables. Using these reference tables allows the EHR data to be quickly accessed and accurately attributed to a particular Patient. Timestamps are also employed advantageously to identify changes to the Patient and Provider identities over time. The local EHR records are preferably sorted and stored in chronological order when received.

It is advantageous for the Aggregator to algorithmically and manually check the EHR data for consistency. Consistency checks flag errors in sequencing, missing procedures and procedures that could not have been performed in view of past procedures and conditions of the Patient. These inconsistencies can be stored and then used to scrub errors from the information stored in the augmented EHR vault 60. Part of the error scrubbing process may require the Aggregator to contact the Provider personally to resolve inconsistency issues. Frequent errors may be formalized in a rules table that is applied to newly received EHR data to ensure ongoing consistency. These actions constitute a quality check on the collection and aggregation of the EHR data, and instill confidence in the accuracy of the augmented EHR data. These types of consistency checks constitute an analytical technique to achieve a more accurate aggregation of EHR data, which becomes particularly important as the size of the aggregated EHR data proliferates.

It is desirable to limit the number of Aggregators or for the Aggregators to share information among themselves. A large number of Aggregators makes it more difficult for a Provider obtain comprehensive EHR data on a Patient. The Provider will be required to send EHR requests 68 to many Aggregators to obtain a completely augmented EHR record for each Patient, since the complete EHR record of each Patient may not be present in the augmented EHR vault 60 of any Aggregator. Under these circumstances, the different Aggregators may establish a procedure for sharing their augmented EHR records for each Patient with each other, to enable each Aggregator to have a complete, accurate and up-to-date augmented EHR record for each Patient. However, once a Provider has obtained a completely augmented EHR record for a Patient from EHR requests 68 sent to many different Aggregators, the next occurrence of an Aggregator sending a pull request 52 to that Provider will result in transferring that completely augmented EHR record stored in that Provider's local memory 34 to Aggregator, thereby providing the Aggregator with a basis to obtain the complete augmented EHR record for the Patient.

The described invention offers many advantages and benefits. A Patient's EHR records are collected, aggregated and augmented by an Aggregator, and the augmented EHR record of each Patient becomes available to Providers. No additional effort is required by the Patient or the Provider to accumulate timely and comprehensive EHR records. Many other advantages, benefits and improvements will also be recognized upon fully appreciating the ramifications of the present invention.

Presently preferred embodiments of the invention and its improvements have been described with a degree of particularity. This description has been made by way of preferred example. It should be understood that the scope of the present invention is defined by the following claims, and should not be unnecessarily limited by the detailed description of the preferred embodiments set forth above.

The invention claimed is:

1. A method of collecting and aggregating EHR data of a Patient to whom Healthcare is delivered by a Provider who creates the EHR data and submits a payment request to a Payer for compensation for delivery of Healthcare to the Patient, comprising:
collecting the EHR data from the Provider for each instance of the Provider delivering Healthcare to the Patient in response to the Provider submitting the payment request to the Payer; and
aggregating the collected EHR data with any pre-existing EHR data to create augmented EHR data for the Patient.

2. A method as defined in claim 1, further comprising:
including in the payment request an identification of the Patient, an identification of the Provider, and a basic description of the Healthcare delivered to the Patient; and
requesting the Provider identified in the payment request to supply the EHR data created by the Provider for the Patient identified in the payment request.

3. A method as defined in claim 2, further comprising:
additionally requesting the Provider identified in the payment request to supply the EHR data created by the Provider for the Patient identified in the payment request by reference to at least one aspect of the basic description of the Healthcare delivered contained in the payment request.

4. A method as defined in claim 2, wherein the EHR data of the Patient is collected, aggregated and augmented by a Provider.

5. A method as defined in claim 4, wherein the Provider that collects, aggregates and augments the EHR data of the Patient is different from each other Provider that delivers Healthcare to the Patient.

6. A method as defined in claim 1, wherein the EHR data of the Patient is collected, aggregated and augmented by an Aggregator that has authority to access the EHR data of the Patient created by the Provider, and the Aggregator is not a Provider who submits the payment request to the Payer.

7. A method as defined in claim 6, wherein the Aggregator derives the authority to communicate with each Provider who delivers Healthcare to the Patient by obtaining the consent for such communication from the Patient.

8. A method as defined in claim 6, wherein the Aggregator derives the authority to communicate with each Provider who creates EHR data of the Patient by obtaining lawful regulatory status as a Provider.

9. A method as defined in claim 6, wherein:
the Aggregator is an entity separate from the Provider;
the Payer transmits a payment request trigger to the Aggregator after the Provider submits the payment request to the Payer,
the payment request trigger includes an identification of the Patient, an identification of the Provider, and a basic description of the Healthcare delivered by the identified Provider to the Patient; and
the Aggregator responds to the payment request trigger by requesting the identified Provider to supply the EHR data created by the Provider for the Healthcare delivered to the identified Patient.

10. A method as defined in claim 9, wherein:
the Aggregator responds to the payment request trigger by requesting the identified provider to supply the EHR data created by the Provider for Healthcare delivered to the identified Patient by reference at least one aspect to the basic description of the Healthcare delivered contained in the payment request trigger.

11. A method as defined in claim 1, further comprising:
collecting and aggregating pre-existing EHR data of the Patient from the Payer who previously compensated a Provider for delivering Healthcare to the Patient.

12. A method as defined in claim 11, further comprising:
collecting and aggregating pre-existing EHR data of the Patient from multiple different Payers.

13. A method as defined in claim 1, further comprising:
collecting and aggregating pre-existing EHR data of the Patient from Providers who previously delivered Healthcare to the Patient.

14. A method as defined in claim 1, further comprising:
collecting and aggregating pre-existing EHR data of the Patient from statements describing Healthcare delivered by the Provider that were obtained by the Patient from the Provider and submitted to the Aggregator.

15. A method as defined in claim 1, further comprising:
collecting and aggregating pre-existing medical information of the Patient by accessing a PHR vault of the Patient and obtaining medical information of the Patient recorded in that PHR vault.

16. A method as defined in claim 1, further comprising:
collecting and aggregating EHR data of the Patient by periodically requesting the EHR data from each Provider who has previously delivered Healthcare to the Patient within a predetermined amount of elapsed time after the Provider has previously delivered the Healthcare.

17. A method as defined in claim 1, further comprising:
including in the payment request an identification of the Patient, an identification of the Provider, and a basic description of the Healthcare delivered to the Patient;
collecting and aggregating EHR data of the Patient by using the identification of the Patient and the identification of the Provider and at least one aspect of the basic description of the Healthcare delivered to the Patient; and
requesting EHR data for the identified Patient from a class of other Providers for which there is a reasonable probability of delivering Healthcare to the Patient based on at least one aspect of the basic description of the Healthcare delivered to the Patient contained in the payment request.

18. A method as defined in claim 17, further comprising:
limiting the request for EHR data to those other Providers of the class that have geographic addresses within a predetermined geographic proximity of the address of the one of the Provider submitting the payment request or the Patient.

19. A method as defined in claim 1, further comprising:
collecting and aggregating EHR data of the Patient by periodically requesting the EHR data from each Provider who has an address within a predetermined geographic proximity of the address of one of the Provider submitting the payment request or the Patient.

20. A method as defined in claim 1, wherein:
a Provider requests and obtains the aggregated EHR data of a Patient in connection with delivering Healthcare to the Patient.

21. A method as defined in claim 20, wherein:
the Provider updates any EHR data of the Provider for the Patient with the augmented EHR data received.

22. A method as defined in claim 20, further comprising:
augmenting EHR data of the Patient by periodically collecting, aggregating and augmenting the EHR data from each Provider who has previously requested augmented EHR data for the Patient within a predetermined amount of elapsed time after the Provider requested the augmented EHR data.
